(19) United States
(12) Patent Application Publication
(10) Pub. No.: US 2024/0186566 A1
(43) Pub. Date: Jun. 6, 2024

(54) LITHIUM-BASED SOLID ELECTROLYTE MATERIAL

(71) Applicant: LIVENT LITHIUM LLC, Philadelphia, PA (US)

(72) Inventors: Jian Xia, Belmont, NC (US); Rebecca Black, Charlotte, NC (US); Anantharamulu Navulla, Cary, NC (US); Marina Yakovleva, Gastonia, NC (US); Kenneth Brian Fitch, Cherryville, NC (US)

(21) Appl. No.: 18/205,764

(22) Filed: Jun. 5, 2023

Related U.S. Application Data
(60) Provisional application No. 63/430,206, filed on Dec. 5, 2022.

(51) Int. Cl. H01M 10/0562; H01M 10/056

(52) U.S. Cl. CPC H01M 10/0562; H01M 10/056; H01M 2300/008; H01M 2300/0088

(57) ABSTRACT

The present invention provides a solid electrolyte material which may be used in solid-state batteries including semi-solid flow batteries. The resulting solid-state battery may have improved cyclability and increased cycle life. The lithium-based solid electrolyte material may comprise a lithium-based solid electrolyte material comprising Li₃₊ₓAₓB₂₋ₓSi₂PO_{12-d}C_{d} wherein A is a trivalent metal, B is a transition metal, C is a halogen or sulfur, x is 0.01 to 0.5, and d is 0 to 12.

In an alternate embodiment, the present invention provides a hybrid solid electrolyte comprising the lithium-based solid electrolyte material comprising Li₃₊ₓAₓB₂₋ₓSi₂PO_{12-d}C_{d} wherein A is a trivalent metal, B is a transition metal, C is a halogen or sulfur, x is 0.01 to 0.5, and d is 0 to 12, a polymer solid electrolyte and an inorganic salt.

### RELATED APPLICATION

The following non-provisional utility application claims priority to U.S. Provisional No. 63/430,206 filed Dec. 5, 2022, the disclosure of which is incorporated by reference in its entirety.

### FIELD OF THE INVENTION

The present invention relates to a solid electrolyte material, and particularly a hybrid solid electrolyte material which may be incorporated into a solid-state battery.

### BACKGROUND OF THE INVENTION

Lithium and lithium-ion secondary or rechargeable batteries have found use in certain applications such as in cellular phones, camcorders, and laptop computers, and even more recently, in larger power application such as in electric vehicles, hybrid electric vehicles, eVTOL and other air mobility applications. It is preferred in these applications that the secondary batteries have the highest specific capacity possible but still provide safe operating conditions and good cyclability so that the high specific capacity is maintained in subsequent recharging and discharging cycles.

Although there are various constructions for secondary batteries, each construction includes a positive electrode (or cathode), a negative electrode (or anode), a separator that separates the cathode and anode, an electrolyte in electrochemical communication with the cathode and anode. For secondary lithium batteries, lithium ions are transferred from the anode to the cathode through the electrolyte when the secondary battery is being discharged, i.e., used for its specific application. During the discharge process, electrons are collected from the anode and pass to the cathode through an external circuit. When the secondary battery is being charged, or recharged, the lithium ions are transferred from the cathode to the anode through the electrolyte.

New lithium-ion cells or batteries are initially typically in a discharged state. During the first charge of lithium-ion cell, lithium moves from the cathode material to the anode active material. The lithium moving from the cathode to the anode reacts with an electrolyte material at the surface of the graphite anode, causing the formation of a passivation film on the anode. The passivation film formed on the graphite anode is a solid electrolyte interface (SEI). Upon subsequent discharge, the lithium consumed by the formation of the SEI is not returned to the cathode. This results in a lithium-ion cell having a smaller capacity compared to the initial charge capacity because some of the lithium has been consumed by the formation of the SEI. The partial consumption of the available lithium on the first cycle reduces the capacity of the lithium-ion cell. This phenomenon is called irreversible capacity and is known to consume about 10% to more than 20% of the capacity of a lithium-ion cell. Thus, after the initial charge of a lithium-ion cell, the lithium-ion cell loses about 10% to more than 20% of its capacity.

Many lithium-ion batteries utilize liquid electrolytes. Liquid electrolytes may have cell leakage concerns, thermal runaway issues, and there is the possibility of side reactions other than the conventional battery reactions leading to safety concerns and problems. In order to avoid these concerns and problems, it has been suggested to utilize an all-solid-state battery in which the liquid electrolyte is replaced with a solid electrolyte or hybrid solid electrolyte. Batteries including solid electrolytes or hybrid solid electrolytes, however, often have a smaller discharge capacity when compared to batteries utilizing a liquid electrolyte.

Therefore, it would be desirable to provide a solid-state battery having a high charge and discharge capacity and energy density.

### SUMMARY OF THE INVENTION

The present invention provides a solid electrolyte material which may be used in a solid-state battery. Solid-state batteries may include semi-solid flow batteries. The resulting solid-state battery may have improved cyclability and increased cycle life. The lithium-based solid electrolyte material may comprise a lithium-based solid electrolyte material comprising Li₃₊ₓAₓB₂₋ₓSi₂PO_{12-d}C_{d} wherein A is a trivalent metal, B is a transition metal, C is a halogen or sulfur, x is 0.01 to 0.5, and d is 0 to 12.

In an alternate embodiment, the present invention provides a hybrid solid electrolyte comprising the lithium-based solid electrolyte material comprising Li₃₊ₓAₓB₂₋ₓSi₂PO_{12-d}C_{d} wherein A is a trivalent metal, B is a transition metal, C is a halogen or sulfur, x is 0.01 to 0.5, and d is 0 to 12, a polymer solid electrolyte and an inorganic salt.

### BRIEF DESCRIPTION OF THE DRAWINGS

FIG. 1 is a diagram illustrating a solid-state battery according to the present invention.

FIG. 2 is a powder x-ray diffraction pattern of the solid electrolyte of Example 1.

FIG. 3 is a powder x-ray diffraction pattern of the solid electrolyte of Example 2.

FIG. 4 is a plot showing the cycle performance of various coin cells using the hybrid solid electrolyte of Example 2.

FIG. 5 is a powder x-ray diffraction pattern of the solid electrolyte of Example 3.

FIG. 6 is a plot showing the cycle performance of various coin cells using the hybrid solid electrolyte of Example 3.

### DETAILED DESCRIPTION

The foregoing and other aspects of the present invention will now be described in more detail with respect to the description and methodologies provided herein. It should be appreciated that the invention may be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

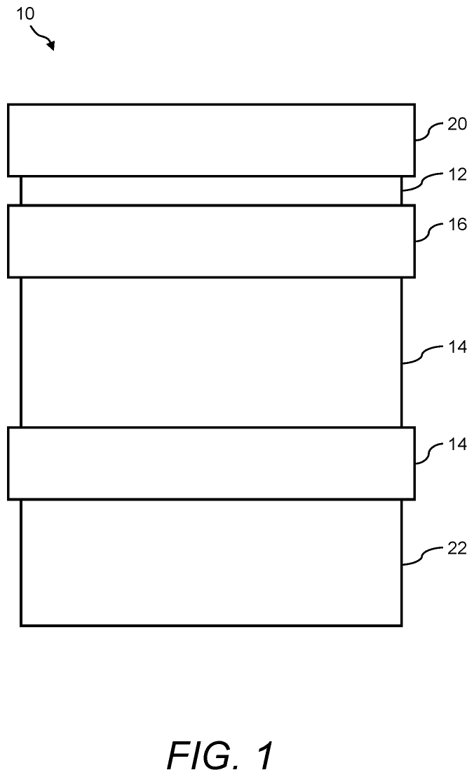

FIG. 1 is a diagram illustrating a solid-state battery 10 of the invention. The solid-state battery may include an anode 12, a cathode 14 and a lithium-based solid electrolyte 16 according to the present invention. The solid-state battery may include semi-solid flow patterns. The solid-state battery may further include an anode current collector 20 and a cathode current collector 22.

The lithium-based solid electrolyte may have a NASICON-type crystal structure and may have either a rhombohedral or monoclinic structure. Lithium provides advantages over sodium in that lithium has the lowest standard reduction potential (−3.07 v) which results in a high cell nominal voltage. Additionally, lithium-based anodes and cathodes will form more stable and reversible batteries as compared to sodium-based compounds.

Specifically, the lithium-based solid electrolyte may comprise Li₃₊ₓAₓB₂₋ₓSi₂PO_{12-d}C_{d} wherein A is a trivalent metal, B is a transition metal, C is a halogen, x is 0.01 to 0.5, and d is 0 to 12. The trivalent metal may be selected from the group consisting of Sc, Y, La, Cr, Al, Fe, V, Cr, In, Ga, and Lu. The transition metal may be selected from the group consisting of Ti, Ge, Ta, Zr, Sn, Fe, V. Hf, Nb, Sb and As. Exemplary halogens may include chlorine, fluorine, bromine and iodine when d is greater than 0, and d may be 0.05 to 0.1. C also may be sulfur.

Specific lithium-based solid electrolyte materials may include Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}Sc_{0.4}Si₂PO_{11.9}Cl_{0.1}, Li_{3.25}Zr_{1.75}Sc_{0.25}Si₂PO_{11.95}Cl_{0.05}, Li_{3.25}Zr_{1.75}Sc_{0.25}Si₂PO_{11.9}Cl_{0.1}, and Li_{3.1}Zr_{1.9}Sc_{0.1}SiPO₁₂.

In one embodiment, the solid electrolyte may be a hybrid solid electrolyte and include the above lithium-based solid electrolyte material, a polymer solid electrolyte and an inorganic salt. Exemplary polymer solid electrolytes may include polyethylene oxide (PEO), polysiloxane (PSO), polypropylene carbonate (PPC), polyethylene carbonate (PEC), polyvinyl chloride (PVC), polyacrylonitrile (PAN), polyacrylic acid (PAA), polyvinylidene fluoride or polyvinylidene difluoride (PVDF), poly(vinylidene fluoride-co-hexafluoropropylene) (PVDF-HFP), polymethyl methacrylate (PMMA), n-hydroxysuccinimide (NHD), polypropylene glycol (PPG), polydimethylsiloxane (PDMS), polypropylene carbonate (PPC), polycaprolactone (PCL), polytrimethylene carbonate (PTMC) and polyethylenimine (PEI) or a polymeric ionic liquid (PIL). Exemplary inorganic salts may include lithium bis(trifluoromethanesulfonyl)imide (LiTFSi), lithium bis(fluorosulfonyl)imide (LiFSi), lithium hexafluorophosphate (LiPF₆), lithium perchlorate (LiCLO₄), lithium tetrafluoroborate (LiBF₄), lithium sulfate (Li₂SO₄), trifluoromethyl radical (CF₃), lithium hexafluoroarsenate (LiAsF₆), lithium bis(oxalate)borate (LiBOB) and lithium difluoro(oxalate)borate (LiDFOB). The lithium-based solid electrolyte may be formed or synthesized using known solution methods including dissolving stoichiometric amounts of precursors in a solvent such as water or ethanol or a mixture thereof. The dissolved precursors may then be mixed followed by solvent evaporation and calcination at temperatures from 500° C. to 1100° C.

The resulting solid electrolyte or hydrid solid electrolyte may have a high ionic conductivity in the range of 10⁻³ S/cm to 10⁻⁵ S/cm.

The anode of the solid-state battery may be formed of a host material capable of absorbing and desorbing lithium in an electrochemical system with the stabilized lithium metal powder dispersed in the host material. For example, the lithium present in the anode may intercalate in, alloy with or be absorbed by the host material when the battery (and particularly the anode) is recharged. The host material may include materials capable of absorbing and desorbing lithium in an electrochemical system such as carbonaceous materials; materials containing Si, Sn, tin and silicon oxides or composite tin and or silicon alloys or intermetallics; transition metal oxides such as cobalt oxide; lithium metal nitrides such as Li₃₋ₓCoₓN where 0<x<0.5, and lithium metal oxides such as Li₄Ti₅O₁₂.

The cathode may be formed of an active material, which is typically combined with a carbonaceous material and a binder polymer. The active material used in the cathode may preferably be a material that may be lithiated at a useful voltage (e.g., 2.0 to 5.0 V versus lithium). Preferably, non-lithiated materials such as MnO₂, V₂O₅ or MoS₂, certain transition metal phosphates, certain transition metal fluorides, sulfur, or mixtures thereof, may be used as the active material. However, lithiated materials such as LiMn₂O₄, LiMn_{1.5}Ni_{0.5}O₄, LiMPO₄ (M=Fe, Co, Ni), LiMO₂ (M=Co, Mn, Fe, Ni), LiNiₓMn_{y}Co_{z}O₂ with x+y+z=1 and LiNiₓCo_{y}Al_{z}O₂ with x+y+z=1 may also be used. The non-lithiated active materials may be selected because they generally have higher voltage plateau, better safety, lower voltage cost and broader choice than the lithiated active materials in this construction and thus may provide increased power over secondary batteries that use only lithiated active materials. Furthermore, because the anode includes lithium as discussed below, it is not necessary that the cathode includes a lithiated material for the secondary battery to operate. The amount of active material provided in the cathode may preferably be sufficient to accept the removable lithium present in the anode

In one embodiment, a printable lithium composition may be deposited or applied to an active anode material on a current collector namely to form a prelithiated anode. As disclosed in U.S. application Ser. No. 17/324,499, and U.S. Ser. No. 18/205,712, filed concurrently herewith on Jun. 5, 2023, the disclosures of which are incorporated by reference in their entireties, the printable lithium composition may include a lithium metal powder, a polymer binder, a rheology modifier and may further include a solvent. The polymer binder may be compatible with the lithium metal powder. The rheology modifier may be compatible with the lithium metal powder and the polymer binder. The solvent may be compatible with the lithium metal powder and with the polymer binder. The lithium metal powder may be in the form of a finely divided powder. The lithium metal powder typically has a mean particle size of less than about 80 microns, often less than about 40 microns and sometimes less than about 20 microns. The lithium metal powder may be a low pyrophoricity stabilized lithium metal power (SLMP®) available from Livent USA Corp. The current collector materials may be a foil, mesh, or foam and conventional metals such as copper or nickel. Application may be via spraying, extruding, coating, printing, painting, and dipping, and are described in U.S. application Ser. Nos. 16/359,707 and 16/359,723.

The present invention may be further illustrated by reference to the examples, but the invention should not be limited by the following examples.

### EXAMPLES

### Example 1 (Synthesis of Li_{3.4}Zr_{1.6}Sc_{0.4}Si₂PO₁₂)

Step 1: Prepare the following solutions separately.
(a) 50 mL of 4M HNO₃ from original or concentrated HNO₃ (70% or 15.8 M) by adding 37.4 mL to 12.6 mL of HNO₃ distilled water
(b) Provide Si(C₂H₅O)₄ in 30 mL distilled water and 20 mL ethanol and adjust the pH to 1 by adding the 4M HNO₃ of (a)
(c) Provide LiOH in 50 mL distilled water (50 mL)
(d) Provide ZrO(NO₃)₂·xH₂O in 100 mL distilled water (100 mL)
(e) Provide Sc(NO₃)₃·xH₂O in 50 mL distilled water (50 mL)
(f) Provide NH₄H₂PO₄ in 50 mL distilled water (50 mL)

Step 2: Mix four solutions (b) to (f) under agitation in a beaker at room temperature. A white precipitate or gel will be formed at this stage.

Step 3: Slowly dry the gel at 100° C. until you have a dry precursor.

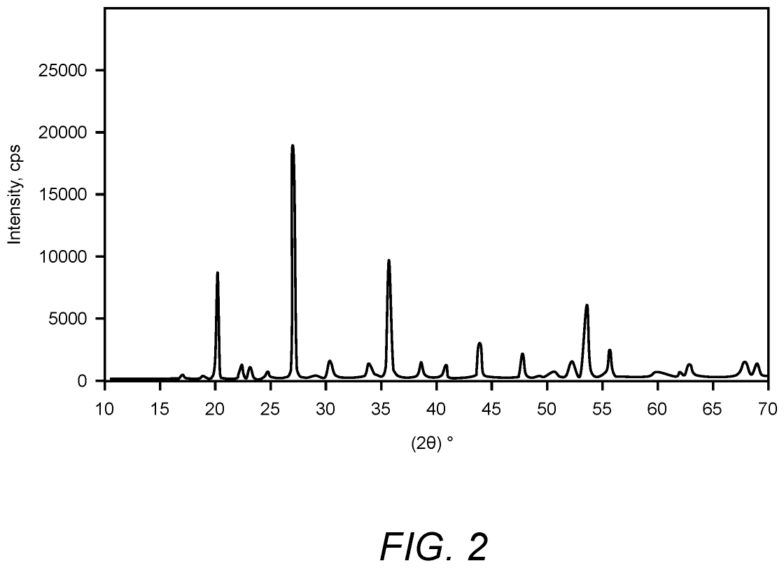

Step 4: Grind the dry precursor of Step 3 using a mortar and pestle and calcine between 750-1150° C., in argon for 12-24 hours. The powder x-ray diffraction pattern is provided at FIG. 2.

### Example 2

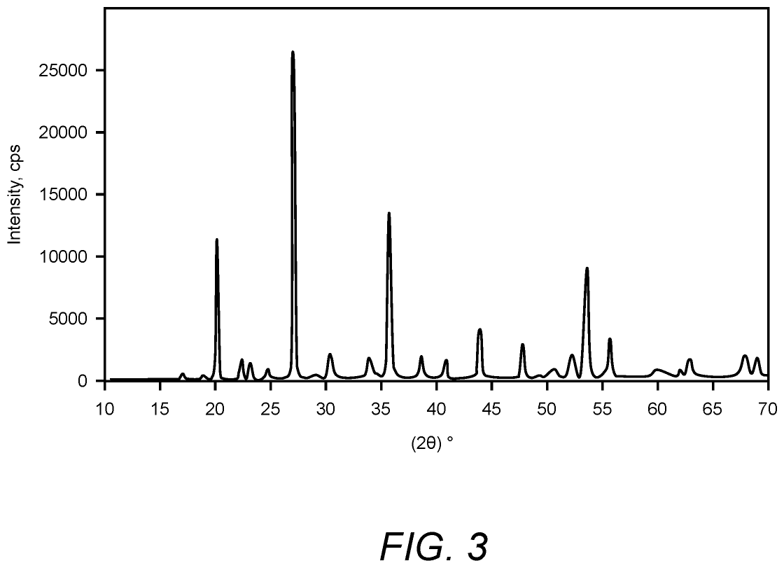

The same procedure of Example 1 was utilized to form Li_{3.25}Zr_{1.75}Sc_{0.25}Si₂PO₁₂. The powder x-ray diffraction pattern is provided at FIG. 3.

TABLE 1

| Pellet | R (ohm) | t (cm) | σ (S/cm) | Area (cm²) |
|---|---|---|---|---|
| 600 mg | 500 | 0.1755 | 2.6E−04 | 1.327 |
| 900 mg | 552 | 0.2225 | 3.0E−04 | 1.327 |

Conductivity Calculation: σ = (1/R)*(t/A)

Table 1 shows that acceptable ionic conductivity may be achieved with the solid electrolyte of Example 2. O

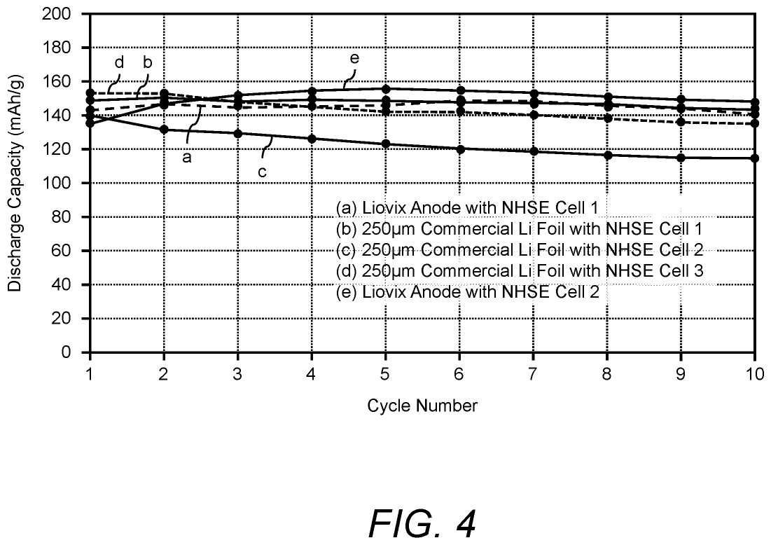

A coin cell is formed using a Liovix® printed lithium foil anode, LiFePO₄ as the cathode and a hybrid solid electrolyte comprising the solid electrolyte of Example 2, PEO and LLTZO. A conventional anode coin cell is also formed. The Liovix® printed lithium foil anode has a thickness of 20 μm and the commercial lithium foil anode having a thickness of 250 μm. Cycling was at 2.8V to 3.8V, 0.1 C to 0.1 CC. Solid cells are at 45° C. FIG. 4 demonstrates that that the combination of a printable lithium foil or a conventional anode performs substantially equally with the Example 2 solid electrolyte with the 20 μm Liovix® foil anode performing slightly better than the conventionally available 250 μm anode.

### Example 3

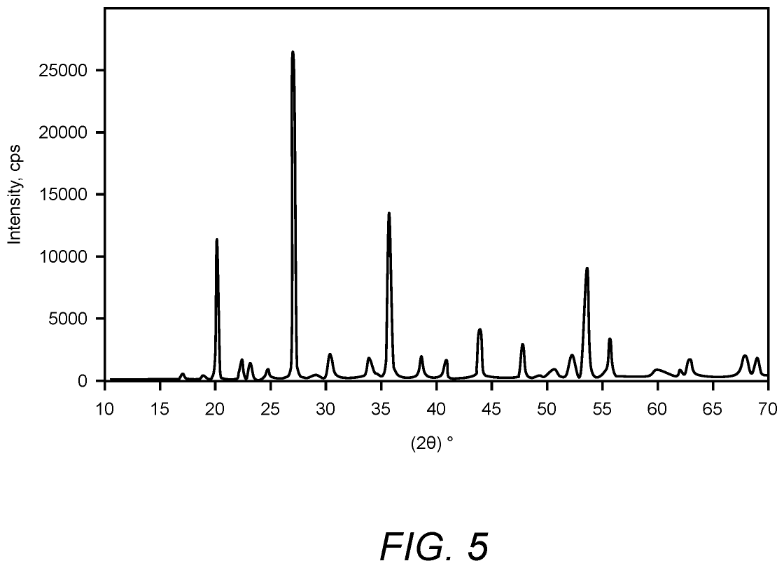

The same procedures of Example 1 was utilized to form Li_{3.1}Zr_{1.9}Sc_{0.1}Si₂PO₁₂. The powder x-ray diffraction pattern is provided at FIG. 5.

TABLE 2

| Pellet | R (ohm) | t (cm) | σ (S/cm) | Area (cm²) |
|---|---|---|---|---|
| 600 mg | 1745 | 0.1626 | 7.0E−05 | 1.327 |
| 900 mg | 1273 | 0.2252 | 1.3E−04 | 1.327 |

Conductivity Calculation: σ = (1/R)*(t/A)

Table 2 shows that acceptable ionic conductivity may be achieved with the solid electrolyte of Example 3.

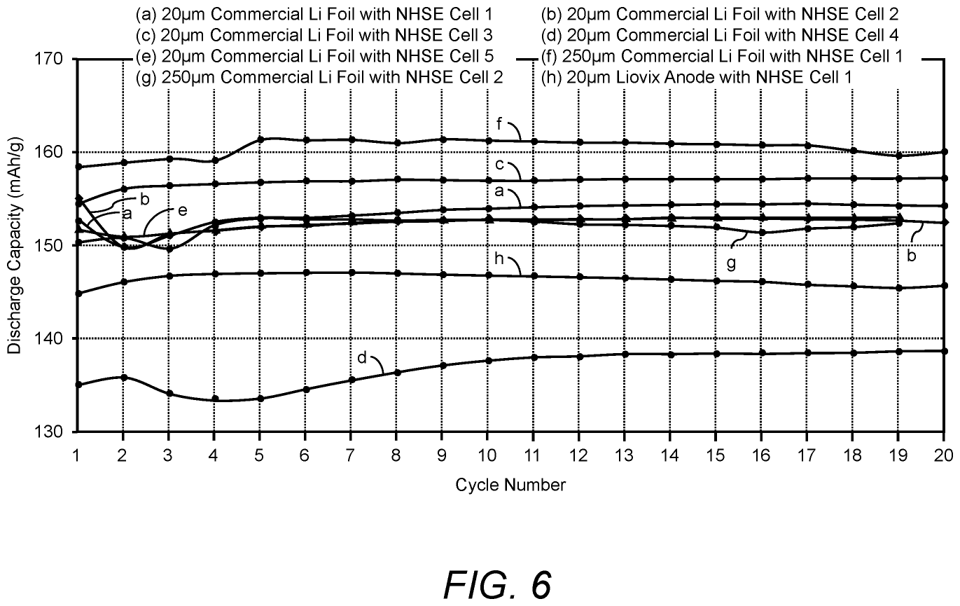

A coin cell is formed using a Liovix® printable lithium foil anode, LiFePO₄ as the cathode and a hybrid solid electrolyte comprising the solid electrolyte of Example 3, PEO and LLTZO. The Liovix® printed lithium foil anode has a thickness of 20 μm and the conventionally available lithium foil anodes have a thickness of 20 μm and 250 μm. The coin cells were cycled at 45° C. between 2.8V and 3.8V, with a constant current constant voltage corresponding to 0.1 C and current cutoff at 0.1 C. FIG. 6 demonstrates that that the combination of a printed lithium foil or a 20 μm or 250 μm conventionally available anode performs substantially equally with the Example 3 solid electrolyte.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

That which is claimed is:

1. A lithium-based solid electrolyte material comprising Li₃₊ₓAₓB₂₋ₓSi₂PO_{12-d}C_{d} wherein:
A is a trivalent metal
B is a transition metal
C is a halogen or sulfur
x is 0.01 to 0.5
d is 0 to 12

2. The lithium-base solid electrolyte material of claim 1, wherein the trivalent metal is selected from the group consisting of Sc, Y, La, Cr, Al, Fe, V, Cr, In, Ga, and Lu.

3. The lithium-based solid electrolyte material of claim 1, wherein the transition metal is selected from the group consisting of Ti, Ge, Ta, Zr, Sn, Fe, V, Hf, Nb, Sb and As.

4. The lithium-based solid electrolyte material of claim 1, wherein the halogen is selected from the group consisting of chlorine, fluorine, bromine, and iodine.

5. The lithium-based solid electrolyte material of claim 1, wherein d is 0.

6. The lithium-based solid electrolyte material of claim 1, wherein the material has a NASICON-type crystal structure.

7. The lithium-based solid electrolyte material of claim 1, wherein the NASICON-type crystal structure is selected from the group consisting of a rhombohedral and a monoclinic structure.

8. A hybrid solid electrolyte comprising the lithium-based solid electrolyte material of claim 7, a polymer solid electrolyte and an inorganic salt.

9. A hybrid electrolyte of claim 8, wherein the polymer solid electrolyte is polyethylene oxide (PEO), polysiloxane (PSO), polypropylene carbonate (PPC), polyethylene carbonate (PEC), polyvinyl chloride (PVC), polyacrylonitrile (PAN), polyacrylic acid (PAA), polyvinylidene fluoride or polyvinylidene difluoride (PVDF), poly(vinylidene fluoride-co-hexafluoropropylene) (PVDF-HFP), polymethyl methacrylate (PMMA), n-hydroxysuccinimide (NHD), polypropylene glycol (PPG), polydimethylsiloxane (PDMS), polypropylene carbonate (PPC), polycaprolactone (PCL), polytrimethylene carbonate (PTMC) and polyethylenimine (PEI) or a polymeric ionic liquid (PIL).

10. A hybrid solid electrolyte of claim 9, wherein the inorganic salt is selected from the group consisting of lithium bis(trifluoromethanesulfonyl)imide (LiTFSi), lithium bis(fluorosulfonyl)imide (LiFSi), lithium hexafluorophosphate (LiPF₆), lithium perchlorate (LiCLO₄), lithium tetrafluoroborate (LiBF₄), lithium sulfate (Li₂SO₄), trifluoromethyl radical (CF₃), lithium hexafluoroarsenate (LiAsF₆), lithium bis(oxalate)borate (LiBOB) and lithium difluoro(oxalate)borate (LiDFOB).

11. A solid-state battery comprising a cathode, an anode, and a hybrid solid electrolyte according to claim 8.

12. A hybrid solid electrolyte comprising a solid electrolyte material selected from the group consisting of Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}Sc_{0.4}Si₂PO_{11.9}Cl_{0.1}, Li_{3.25}Zr_{1.75}Sc_{0.25}Si₂PO_{11.95}Cl_{0.05}, and Li_{3.25}Zr_{1.75}Sc_{0.25}Si₂PO_{11.9}Cl_{0.1}, a polymer solid electrolyte and an inorganic salt.

13. A hybrid electrolyte of claim 12, wherein the polymer solid electrolyte is polyethylene oxide (PEO), polysiloxane (PSO), polypropylene carbonate (PPC), polyethylene carbonate (PEC), polyvinyl chloride (PVC), polyacrylonitrile (PAN), polyacrylic acid (PAA), polyvinylidene fluoride or polyvinylidene difluoride (PVDF), poly(vinylidene fluoride-co-hexafluoropropylene) (PVDF-HFP), polymethyl methacrylate (PMMA), n-hydroxysuccinimide (NHD), polypropylene glycol (PPG), polydimethylsiloxane (PDMS), polypropylene carbonate (PPC), polycaprolactone (PCL), polytrimethylene carbonate (PTMC) and polyethylenimine (PEI) or a polymeric ionic liquid (PIL).

14. A hybrid solid electrolyte of claim 12, wherein the inorganic salt is selected from the group consisting of lithium bis(trifluoromethanesulfonyl)imide (LiTFSi), lithium bis(fluorosulfonyl)imide (LiFSi), lithium hexafluorophosphate (LiPF₆), lithium perchlorate (LiCLO₄), lithium tetrafluoroborate (LiBF₄), lithium sulfate (Li₂SO₄), trifluoromethyl radical (CF₃), lithium hexafluoroarsenate (LiAsF₆), lithium bis(oxalate)borate (LiBOB) and lithium difluoro(oxalate)borate (LiDFOB).

15. A solid-state battery comprising a cathode, an anode, and a hybrid solid electrolyte according to claim 12.
